(19) United States
(12) Patent Application Publication
(10) Pub. No.: US 2002/0198730 A1
(43) Pub. Date: Dec. 26, 2002

(54) System and method for carpet recovery

(76) Inventors: Michael Robert Costello, Martinez, GA (US); Michael David Lawrence, Glen Allen, VA (US); Truc Nguyen Brown, Midlothian, VA (US); Edward Aloysius Duffy, Chesterfield, VA (US); Andres Camacho, Richmond, VA (US); David Franklin Blackwood, Midlothian, VA (US)

Correspondence Address: Honeywell International Inc., 15801 Woods Edge Road, Colonial Heights, VA, 23834, US

(21) Appl. No.: 09/888,987

(22) Filed: Jun. 25, 2001

(51) Int. Cl. G06F 17/60

(52) U.S. Cl. 705/1

(57) ABSTRACT

A method for recovering carpet comprising polymeric fibers. A seller, i.e. retailer, manufacturer or distributor installs a carpet at a consumer location and establishes and maintains a database of installed carpet information comprising carpet type, installation date and consumer identification data. The useful lifetime of the installed carpet is estimated, and the seller contacts the consumer within a determined period of time of the end of the estimated useful lifetime of the carpet. The seller then preferably provides the consumer with an incentive to replace the carpet, such as a credit towards the purchase of a replacement carpet from the seller. The seller then collects the used carpet and sorts the collected carpet according to polymeric fiber type. At least one type of polymeric fiber is converted into a recovered polymer composition, such as by depolymerizing it into its monomeric components and then repolymerizing the monomeric components to form a recovered polymer composition. The recovered polymer composition may then be formed into an article such as fibers which are used to form a new carpet. The seller preferably provides the consumer with a replacement carpet. This invention serves to facilitate carpet recycling and promote repeat carpet sales.

### BACKGROUND OF THE INVENTION

1. Field of the Invention

The present invention relates to carpet recycling. More particularly, it relates to a method for recovering used carpets comprising polymeric fibers.

2. Description of the Related Art

Due to increasing concerns over preserving natural resources and protecting the environment, greater efforts have been directed toward recovering discarded products and recycling them for future use. One such product that has been targeted for recycling is carpet, particularly the large amounts of polyamides contained in many common carpets.

Thousands of tons of carpet waste are discarded in landfills and other garbage depositories each year. Various methods have been developed for the recovery and recycling of polyamides from carpet waste in order to minimize the discarding of such carpet waste. U.S. Pat. No. 5,898,063 to Stefandl teaches a process for recycling nylon in a nylon-containing carpet. According to this process, nylon in the carpet is dissolved using a solvent. The solvent containing the dissolved nylon is then removed from the remaining solid residue. The solvent-nylon solution is then cooled to precipitate and recover the nylon.

U.S. Pat. No. 5,840,773 to Booij et al. teaches a process for recycling polyamides from carpet waste by separating the polyamide from the carpet waste with an extraction agent containing an aliphatic alcohol. The polyamide can then be recovered and recycled for further use. In addition, carpet waste containing two polyamides can be treated to separately recover each polyamide. This process provides a high yield of the polyamide.

Conventionally, used carpets have either been disposed of in a landfill by the consumer or a carpet retailer. More recently, some retailers transfer used carpets to a recycling center, but only after a new carpet has been purchased. While techniques for converting used carpet into new products is known, no focused effort has been developed for monitoring carpeting through its complete life cycle through its initial sale, use, removal, recovery and remanufacture of component parts. Carpets may be produced from several different materials such as Nylon 6, nylon 66, polyester, polypropylene, and acrylic. Unfortunately, most recycling processes are designed to process a specific fiber type or a specific carpet backing type. Thus, carpet waste must be sorted by fiber or backing type prior to recycling. The problem is that as different carpet types become mixed, it becomes very difficult to determine fiber type. If the fiber or backing type is unknown, this sorting process often requires specialized equipment and can be very labor intensive and costly.

Thus, it would be desirable to provide a method for efficiently managing a system for carpet sellers to keep track of each consumer and the type of carpet purchased by that consumer. It would also be desirable for the seller to be able to communicate directly with the consumer and notify the consumer when the estimated lifetime of the carpet has ended or is about to end.

The present invention provides a solution to this problem by providing a method for tracking a carpet through its life cycle through recovery. According to the invention, after a carpet is installed at a consumer location, a seller such as a retailer, distributor or manufacturer, then establishes and maintains a database of installed carpet information including carpet type, installation date, location, and consumer identification data. Using this information, the useful lifetime of the installed carpet is estimated. The seller then contacts the consumer within a determined period of time of the estimated useful lifetime of the carpet. The seller may provide the consumer with an incentive to replace the carpet, such as a credit towards the purchase of a new carpet. The seller then collects the used carpet and sorts it according to polymeric fiber type. At least one type of polymeric fiber is converted into a recovered polymer composition, such as by depolymerizing it into its monomeric components and then repolymerizing the monomeric components to form a recovered polymer composition. The recovered polymer composition may then be formed into an article such as fibers which are used to form a new carpet. In a most preferred embodiment, the seller provides the consumer with a replacement carpet thus completing the life cycle. This invention serves to facilitate carpet recycling and promote repeat business for a carpet seller.

### SUMMARY OF THE INVENTION

The invention provides a method for recovering carpet comprising polymeric fibers, which method comprises:

a) establishing and maintaining a database of installed carpet information comprising carpet type, installation date and consumer identification data;

b) estimating the useful lifetime of the installed carpet;

c) contacting the consumer within a determined period of time from the end of the estimated useful lifetime of the carpet;

d) collecting the carpet;

e) sorting the collected carpet according to polymeric fiber type; and

f) converting the polymeric fibers into a recovered polymer composition.

The invention further provides a method for recovering carpet comprising polymeric fibers, which method comprises:

a) installing a carpet at a consumer location;

b) establishing and maintaining a database of installed carpet information comprising carpet type, installation date and consumer identification data;

c) estimating the useful lifetime of the installed carpet;

d) contacting the consumer within a determined period of time of the end of the estimated useful lifetime of the carpet;

e) collecting the carpet;

f) sorting the collected carpet according to polymeric fiber type;

g) depolymerizing the polymeric fibers into their monomeric components;

h) repolymerizing the monomeric components to form a recovered polymer composition, and

i) forming fibers from the recovered polymer composition, and then forming the fibers into a carpet.

The invention still further provides a method for recovering carpet comprising nylon polymeric fibers, which method comprises:

a) establishing and maintaining a database of installed carpet information comprising carpet type, installation date and consumer identification data;

b) estimating the useful lifetime of the installed carpet;

c) contacting the consumer within a determined period of time from the end of the estimated useful lifetime of the carpet using one or more communication methods selected from the group consisting of mail, telephone, telefax, electronic mail, and a global computer network;

d) collecting the carpet;

e) sorting the collected carpet according to polymeric fiber type including nylon polymeric fibers;

f) depolymerizing at least one type of nylon polymeric fiber into its monomeric components;

g) repolymerizing the monomeric components to form a recovered polymer composition, and

h) forming nylon fibers from the recovered polymer composition, and then forming the fibers into a carpet.

### BRIEF DESCRIPTION OF THE DRAWINGS

FIGURE 1 shows a flow chart of a preferred embodiment of the invention.

### DETAILED DESCRIPTION OF THE PREFERRED EMBODIMENT

A method is provided for recycling used carpets comprising polymeric fibers, especially nylon fibers. Carpets are composite structures typically comprising face fibers which are tufted through a supportive scrim to form a pile, i.e., the surface of the carpet, and are attached to at a backing. Typically, a carpet comprises about 20-55 percent by weight face fiber and 45-80 percent by weight backing materials.

Backings typically comprise woven or non-woven fabrics made of one or more natural or synthetic fibers or yarns, such as jute, wool, polypropylene, polyethylene, polyamides, polyesters, and rayon. Films of synthetic materials, such as polypropylene, polyethylene and ethylene-propylene copolymers may also be used to form such backing.

Backings may comprise a single layer or multiple layers, such as a primary and secondary backing attached to each other via an adhesive layer. Examples of suitable adhesives for the adhesive layer nonexclusively include latex, polyvinyl chloride (PVC), ethylene vinyl acetate (EVA), and the like.

Face fibers may comprise one or more different materials, nonexclusively including polymers such as polyamides including nylon 6, nylon 66, polypropylene, polyester, wool, cotton, acrylic, and other fibers. According to the invention, it is preferred that the face fibers comprise a polyamide, most preferably nylon 6. Face fibers and/or backing may additionally contain dyes, soil repellents, stabilizers, other compounds added during fiber and/or carpet manufacture, and various impurities such as dirt may exist on or in the carpet due to use. The carpet may also comprise recycled materials which contain post-consumer or post-industrial recycled materials.

Various types of carpet may be recycled according to the present invention including carpet tile. Carpet tile is a variety of carpet which is produced in small squares and typically has a backing containing a hot melt adhesive such as polyvinyl chloride (PVC), or ethylene vinyl acetate (EVA). Carpet used in the present invention may be either branded or unbranded. Typically a single known fiber type is used to produce each brand name carpet. For example Anso®, Infinity®, and Crushresister® (all registered trademarks of Honeywell Intellectual Properties Inc.) are all brand named carpets which are exclusively made with nylon 6 fiber made by Honeywell International Inc. Branded carpets are preferred for recycling in accordance with the present invention. Carpet used in accordance with the present invention may be worn carpeting or new scrap carpeting.

In a typical life cycle, a carpet is sold to a consumer by a seller, and installed at a consumer location. The seller may be a retailer, distributor or manufacturer of the carpet. The seller then establishes and maintains a database of installed carpet information. The database may be established by any means known in the art for keeping track of information. The information is preferably maintained on a computer database. In a most preferred embodiment, the database may be accessed by a global computer network.

The installed carpet information may comprise any data which may be useful for enabling the seller to contact the consumer in the future, and estimate and track the lifespan of the carpet. Such installed carpet information nonexclusively includes such carpet type, installation date, installation location, expected wear patterns, customer identification data, and the like. Consumer identification data nonexclusively includes the name, address, telephone number, e-mail address, etc. of the consumer, or any other data which would enable the seller to contact the consumer in the future for marketing or sending recycling information, educational information, contact information, and the like. The seller may also wish to obtain information such as the specific market segment to which the carpet has been sold, intended use of the carpet, and estimated foot traffic on certain areas of the carpet. This information would enable the seller to estimate the lifespan of the carpet, and to determine when the carpet should be replaced. Installation date information would be important as a starting point for measuring the estimated lifespan of the carpet. Information such as carpet type, nonexclusively including face fiber type and backing type, would facilitate carpet sorting and recycling in the future. Furthermore, information such as carpet size may be useful in deciding how much effort should be expended for recovering or recycling the carpet at the end of its useful life. The seller may obtain such information using any conventional method of communication. Suitable communication methods nonexclusively include personal contact, mail, telephone, telefax, electronic mail, and use of a global computer network, and the like. According to one embodiment of the invention, a consumer provides information to the seller by filling out a postcard and mailing it to the seller, which seller enters the information into a computer database. In a most preferred embodiment, the consumer enters the necessary information directly into the seller's database over a global computer network.

The seller then estimates the useful lifetime of the installed carpet. Depending on several different factors, the useful lifetime of a carpet can range anywhere from a few months to several years. For example, low grade carpet which may be used for apartment complexes and the like may have an expected life of as little as 1 or 2 years. Commercial grade carpet sold to an office building may have an expected life of up to 8 years. Residential carpet sold to a homeowner may have an expected life of 10 years or more. A carpet's useful lifetime may be estimated using any conventional method and any information deemed useful by those skilled in the art. In one embodiment, the seller estimates the useful lifetime of the carpet using information on the specific market segment to which the carpet has been sold. In another embodiment, the seller uses information on carpet type. In another embodiment, the seller uses information on the intended use of the carpet. After estimating the useful lifetime of the carpet, the seller estimates a carpet expiration date, or date at which the carpet reaches the end of its expected useful lifetime.

Within a determined period of time of the end of the estimated useful lifetime, the seller contacts the consumer. The seller may contact the consumer using one or more conventional methods of communication. Suitable communication methods nonexclusively include personal contact, mail, telephone, telefax, electronic mail, and use of a global computer network, and the like. Preferably, the consumer is contacted via telephone or email. The seller preferably notifies the consumer that the carpet's estimated useful lifetime has ended or is about to end.

The seller may then bid on the service to remove and recycle the used carpet and/or provide the consumer with a replacement carpet. In a most preferred embodiment, the seller provides the customer with an incentive to replace and recycle the carpet. Suitable incentives nonexclusively include cash, coupons, rebates, credits, and the like, and may optionally be applied towards future purchases or services from the seller. In a preferred embodiment, the consumer is required to apply such incentives to future purchases from the seller. In another embodiment, in order to receive an incentive a consumer must provide installed carpet information to the seller for the seller's database. In a most preferred embodiment of the invention, the consumer receives a credit towards a new carpet purchase from the seller. This practice serves to facilitate the recycling process while promoting business for the seller.

The seller collects and sorts the carpet using any means known in the art. In a preferred embodiment, the seller cuts the carpet into pieces and removes it from the consumer location. The collected carpet is then sorted by the seller, preferably by separating portions of the carpet according to face fiber type and/or backing type. The face fiber type and backing type of the carpet may be known or unknown to a seller. In a most preferred embodiment of the invention, these features are known by the seller. In a preferred embodiment, the collected carpet is sorted according to polymeric face fiber type. Such carpet preferably comprises nylon 6, nylon 66, polyester, or polypropylene face fibers. Most preferably, the carpet comprises nylon 6.

If face fiber type and/or backing type are unknown, the seller may arrange for these features to be identified. Such identification may be performed using any suitable conventional method known in the art. U.S. Pat. No. 5,952,660, incorporated herein by reference, describes one approach for identifying the face fiber type of waste carpeting. This approach involves the use of a handheld portable spectroscopic device which can be used for determining face fiber type.

Once collected and sorted, the carpet's polymeric fibers are converted into a recovered polymer composition. This may be done by melting the polymeric fibers to form an extrudable mass or by depolymerizing the fibers into monomer components. Various impurities such as dirt and the like may be removed from the recovered composition, which is then preferably formed into an article by any conventional methods known in the art such molding in a mold and the like.

In a preferred embodiment, the step of converting the polymeric fibers into a recovered polymer composition comprises depolymerizing at least one type of polymeric fiber into its monomeric components. This may be done using any conventional method known to those skilled in the art. One such method is disclosed in commonly assigned U.S. Pat. No. 5,948,908, which is incorporated herein by reference. This involves depolymerizing polycaprolactam waste to form caprolactam, wherein the polycaprolactam waste broken down using superheated steam at a temperature of about 250° C. to 400° C. at a pressure of about 1.5 to 100 atm. Another such method is disclosed in commonly assigned U.S. Pat. No. 5,681,952, which is incorporated herein by reference. Another such method is disclosed in commonly assigned U.S. Pat. No. 5,990,306, incorporated herein by reference, which describes the depolymerization of polyamides from carpet waste by contacting a carpet with steam to obtain crude caprolactam. Any remaining water is then removed, and the crude caprolactam is distilled under pressure and crystallized.

The monomeric components are then preferably repolymerized into a recovered polymer composition and formed into an article. The article may be formed using any conventional means such as molding in a mold and the like. In a preferred embodiment, the recovered polymer composition is formed into polymeric fibers. Any conventional melting and spinning procedures and equipment customarily used in the production of polymeric fibers may be used, such as the method described in U.S. Pat. No. 5,811,040. According to another known method, polymeric fibers may be formed by spinning a melted polymer composition to form molten filaments, quenching the molten filaments, gathering the filaments, drawing the filaments into fibers, and cutting the drawn fibers to desired lengths. Polymeric fibers formed according to the invention can be woven into fabrics or formed into carpets. In a most preferred embodiment, the polymeric fibers are formed into a carpet.

This invention serves to facilitate carpet recycling and promote repeat business for a carpet seller. The invention is particularly useful for recovery of carpet waste in large commercial buildings, such as hotels, which may contain 100,000 pounds or more of the same carpet. Such establishments often have very regular replacement cycles. It is a preferred embodiment of this invention to target large commercial installations for removal and recycling services.

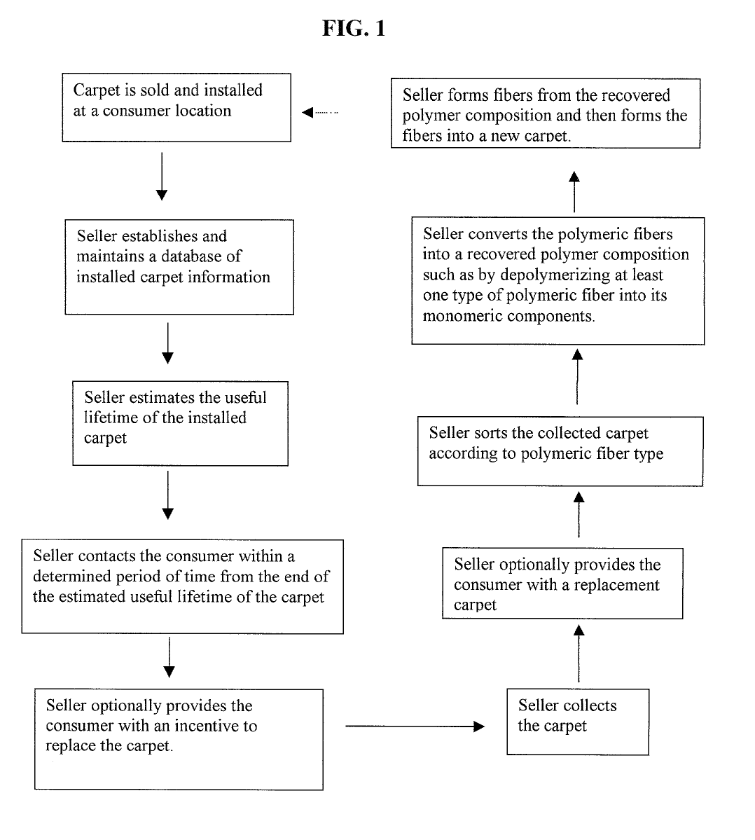

FIGURE 1 illustrates a flow chart of a preferred embodiment of the present invention.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

What is claimed is:

1. A method for recovering carpet comprising polymeric fibers, which method comprises:
a) establishing and maintaining a database of installed carpet information comprising carpet type, installation date and consumer identification data;
b) estimating the useful lifetime of the installed carpet;
c) contacting the consumer within a determined period of time from the end of the estimated useful lifetime of the carpet;
d) collecting the carpet;
e) sorting the collected carpet according to polymeric fiber type; and
f) converting the polymeric fibers into a recovered polymer composition.

2. The method of claim 1 further comprising the subsequent step of forming an article from the recovered polymer composition.

3. The method of claim 1 further comprising the subsequent step of forming polymeric fibers from the recovered polymer composition.

4. The method of claim 1 further comprising the subsequent step of forming polymeric fibers from the recovered polymer composition and then forming the polymeric fibers into a carpet.

5. The method of claim 1 wherein step of converting the polymeric fibers into a recovered polymer composition comprises depolymerizing at least one type of polymeric fiber into its monomeric components.

6. The method of claim 1 wherein step of converting the polymeric fibers into a recovered polymer composition comprises depolymerizing at least one type of polymeric fiber into its monomeric components and then repolymerizing the monomeric components to form the recovered polymer composition.

7. The method of claim 6 further comprising the subsequent step of forming an article from the recovered polymer composition.

8. The method of claim 6 further comprising the subsequent step of forming fibers from the recovered polymer composition.

9. The method of claim 6 further comprising the subsequent step of forming fibers from the recovered polymer composition and then forming the fibers into a carpet.

10. The method of claim 1 wherein step f) comprises depolymerizing a nylon polymeric fiber into its monomeric components.

11. The method of claim 1 wherein step f) comprises depolymerizing a nylon 6 polymeric fiber into its monomeric components.

12. The method of claim 1 wherein step a) is conducted via a global computer network.

13. The method of claim 1 wherein step c) is conducted using one or more communication methods selected from the group consisting of mail, telephone, telefax, electronic mail, and a global computer network.

14. The method of claim 1 further comprising the step after step c) of providing the consumer with a replacement carpet.

15. The method of claim 1 further comprising the preliminary step before step a) of installing a carpet at a consumer location.

16. The method of claim 1 further comprising providing the consumer with an incentive to replace the carpet.

17. A method for recovering carpet comprising polymeric fibers, which method comprises:
a) installing a carpet at a consumer location;
b) establishing and maintaining a database of installed carpet information comprising carpet type, installation date and consumer identification data;
c) estimating the useful lifetime of the installed carpet;
d) contacting the consumer within a determined period of time of the end of the estimated useful lifetime of the carpet;
e) collecting the carpet;
f) sorting the collected carpet according to polymeric fiber type;
g) depolymerizing the polymeric fibers into their monomeric components;
h) repolymerizing the monomeric components to form a recovered polymer composition, and
i) forming fibers from the recovered polymer composition, and then forming the fibers into a carpet.

18. The method of claim 17 wherein the polymeric fibers comprise at least one nylon.

19. The method of claim 17 further comprising providing the consumer with an incentive to replace the carpet.

20. The method of claim 17 further comprising providing the consumer with a replacement carpet.

21. The method of claim 17 wherein step b) is conducted via a global computer network.

22. The method of claim 17 wherein step d) is conducted using one or more communication methods selected from the group consisting of mail, telephone, telefax, electronic mail, and a global computer network.

23. A method for recovering carpet comprising nylon polymeric fibers, which method comprises:
a) establishing and maintaining a database of installed carpet information comprising carpet type, installation date and consumer identification data;
b) estimating the useful lifetime of the installed carpet;
c) contacting the consumer within a determined period of time from the end of the estimated useful lifetime of the carpet using one or more communication methods selected from the group consisting of mail, telephone, telefax, electronic mail, and a global computer network;
d) collecting the carpet;
e) sorting the collected carpet according to polymeric fiber type including nylon polymeric fibers;
f) depolymerizing at least one type of nylon polymeric fiber into its monomeric components;
g) repolymerizing the monomeric components to form a recovered polymer composition, and
h) forming nylon fibers from the recovered polymer composition, and then forming the fibers into a carpet.

24. The method of claim 23 wherein the nylon polymeric fibers comprises nylon 6.

25. The method of claim 23 wherein step a) is conducted via a global computer network.

26. The method of claim 23 further comprising the step after step c) of providing the consumer with a replacement carpet.

27. The method of claim 23 further comprising the preliminary step before step a) of installing a carpet at a consumer location.

28. The method of claim 23 further comprising providing the consumer with an incentive to replace the carpet.
